(19) United States
(12) Patent Application Publication
(10) Pub. No.: US 2024/0217606 A1
(43) Pub. Date: Jul. 4, 2024

(54) Bicycle Locking Station

(71) Applicant: Green Spirit Technologies Inc, North Vancouver (CA)

(72) Inventors: Robert Adamovsky, North Vancouver (CA); Sy Haw WONG, Vancouver (CA); Daryoush Sahebjavaher, North Vancouver (CA); Koosha REZAIEZADEH, North Vanvouver (CA)

(21) Appl. No.: 18/558,173

(22) PCT Filed: May 27, 2022
(86) PCT No.: PCT/IB2022/054986

§ 371 Date: Oct. 30, 2023

Related U.S. Application Data
(60) Provisional application No. 63/181,073, filed on Apr. 28, 2021.

(51) Int. Cl. B62H 3/08; B60L 53/18; B60L 53/30; E05B 47/00

(52) U.S. Cl. CPC B62H 3/08; B60L 53/18; B60L 53/30; E05B 47/0004; E05B 47/0012; E05B 2047/0016; E05B 2047/0017; E05B 2047/0069; E05B 2047/0095

(57) ABSTRACT

A device and method for locking a bicycle to a station at several points on the bicycle. The station's locks are adjustable to accommodate different sizes of bicycles. The locking process may be automated to ensure a proper lock sequence at the command of the user. The station may monitor the state of the lock and communicate with the user via a mobile app.

### FIELD OF THE INVENTION

The invention relates generally to bicycles, in particular devices and systems for locking them.

### BACKGROUND OF THE INVENTION

A common problem for cyclists is what to do with their bicycle when they've reached their destination that is not a secure location such as their home or office. The common solution is to carry a personal lock system that secure the bike frame to the wheel or to a stand which is mounted to the ground. This is still vulnerable to thieves cutting directly through the lock or removing parts of the bicycle.

It is becoming more common to have parking stations for commuter bikes in public areas, such as train stations and shopping centers. Here there may be a metal bracket bolted to the sidewalk which provides a mounting bracket on the sidewalk. These are simple ‘dumb’ terminals that do not provide any feedback or monitoring for the user. The user has to hope that the bike is there when they come back and that the lock is set properly.

Another progressively common bike station is that of communal/shared bikes, whereby a fleet of bikes is used temporarily by a user and returned to one or more parking stations. Here it is important that the bikes are properly locked and can be monitored by the administrative system.

The inventors have appreciated a new way to lock a bike to a station to ensure that it is locked properly and for monitoring by the user or administrative personnel.

### SUMMARY OF THE INVENTION

To address the shortcomings of the current devices, a new device is provided that has these advantages and solves certain problems mentioned above.

In accordance with a first aspect of the invention there is provided a bicycle locking station comprising: a vertically extending structure having an adjustable height bike-frame lock; and a ground-engaging base having two wheel locks and means to adjust the distance between the wheel locks.

The station may further comprise a computer processor and actuators operatively coupled thereto for controlling the locks.

The station may further comprise actuators within the station mechanically coupled to locking rods of the locks to drive the rods between a locked and unlocked position.

The station may further comprise lock sensors for determining whether the locks are in a locked or unlocked position.

The base may comprise rollers proximate the wheel locks to support wheels of the bicycle.

The station may further comprise an electrical power supply and cable for charging e-bikes.

The bike-frame lock may be mounted to and vertically adjustable relative to the vertically extending structure by an actuator to accommodate bicycles of different sizes.

The vertically extending structure may have a vertical channel for slidably receiving the biked frame lock.

The vertically extending structure may be connected to the base.

The bike-frame lock may be a U-shaped lock, slidable to create a gap through which a bicycle's frame may pass.

The wheel locks may comprise C-shaped shackles, rotatable to lock around the bicycle's wheels.

The station may further comprise a plurality of ganged structures, bases and locks to lock several bicycles individually.

The station may further comprise telecommunications hardware for exchanging data with a mobile app or server.

In accordance with a second aspect of the invention there is provided a method of locking a bicycle comprising: positioning the bicycle beside a locking station having three locks; adjusting the height of a frame lock of the station and engaging that lock around the frame of the bicycle; and adjusting the horizontal distance between two-wheel locks and engaging each with a wheel of the bicycle.

The method may comprise unlocking and locking the locks using actuators within the station.

The method may comprise determining whether the locks are in a locked or unlocked position using lock sensors.

The method may further comprise charging the bicycle using a cable powered by the station.

The height of the frame lock may be adjusted using an actuator within the station.

The method may further comprise associating a user with one locking station in a plurality of ganged locking structures and controlling each station when instructed by that user.

The method may comprise exchanging data with a mobile app or server regarding the state of the locks or instructions from a user.

Further aspects of the invention are set out below and in the appended claims. Thus preferred embodiments of the invention enable the device to have some effects or advantages that result from the claims.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1 is a perspective view of bike lock station.

FIG. 2A is a side view of a frame lock from closed to open position.

FIG. 2B is a cross-sectional view of the frame lock from closed to open.

FIG. 3 is a cross-sectional view of ratcheting locking mechanism for a frame.

FIG. 4A is a cross-sectional view of a rotary locking mechanism for a bike frame in an open position.

FIG. 4B is a perspective view of the rotary locking mechanism is an open position.

FIG. 4C is a cross-sectional view of the rotary locking mechanism for a bike frame in an closed position.

FIG. 5A is a side view of C-lock system for bike wheels.

FIG. 5B is a top view of the C-lock system.

FIG. 5C is a perspective view of the C-lock system in an closed position.

FIG. 5D is a perspective view of the C-lock system in open position.

FIG. 5E is an end view of the C-lock system for bike wheels.

FIG. 6 is a cross-sectional view of the C-lock system.

FIG. 7A is a cross-sectional view of an alternative wheel lock.

FIG. 7B is a perspective view of an alternative wheel lock.

FIG. 8 is a system diagram of stations and mobile devices with communications therebetween.

FIG. 9 is a cross-section view of the alternative C-lock system.

FIG. 10 is a cross-section of an alternative frame lock in an open position.

### DETAILED DESCRIPTION OF THE INVENTION

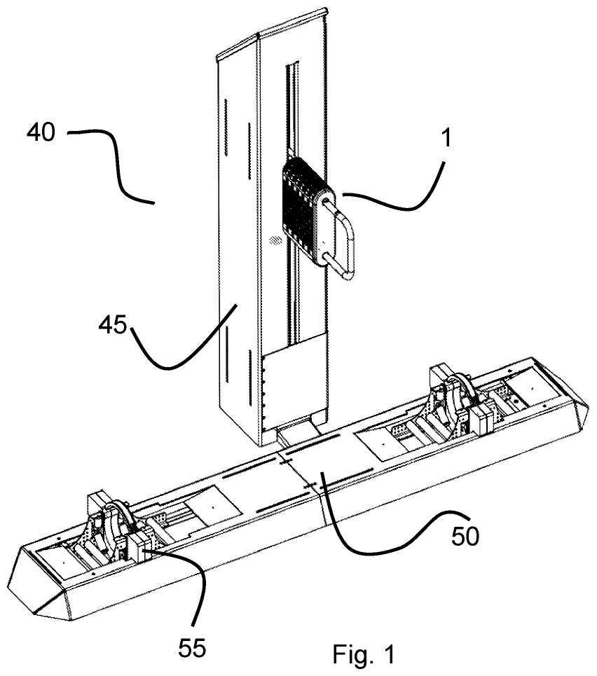

With reference to the accompanying figures, exemplary devices and methods are disclosed for locking a bike at a station 40 using three lock points: the frame and both wheels. As shown in FIG. 1, a frame U-lock (1) is used to lock the main frame of the bike, while the wheels are locked using a pair of wheel locks 55 located on a base 50. The height of the frame lock, and the distance between wheel locks are adjustable to allow the station to accommodate different shapes and sizes of bikes. Rollers may be provided on the base to assist the user in placing the bike.

In some embodiments, locking automation and remote connectivity are provided in the station to improve the locking function and allow monitoring of the bike and station.

Preferably, a “U-lock” design is used to lock the main frame of the bike, while the wheels are locked using a “C-lock” design. The skilled person will appreciate that alternative locking mechanisms may be employed to perform the locking functions.

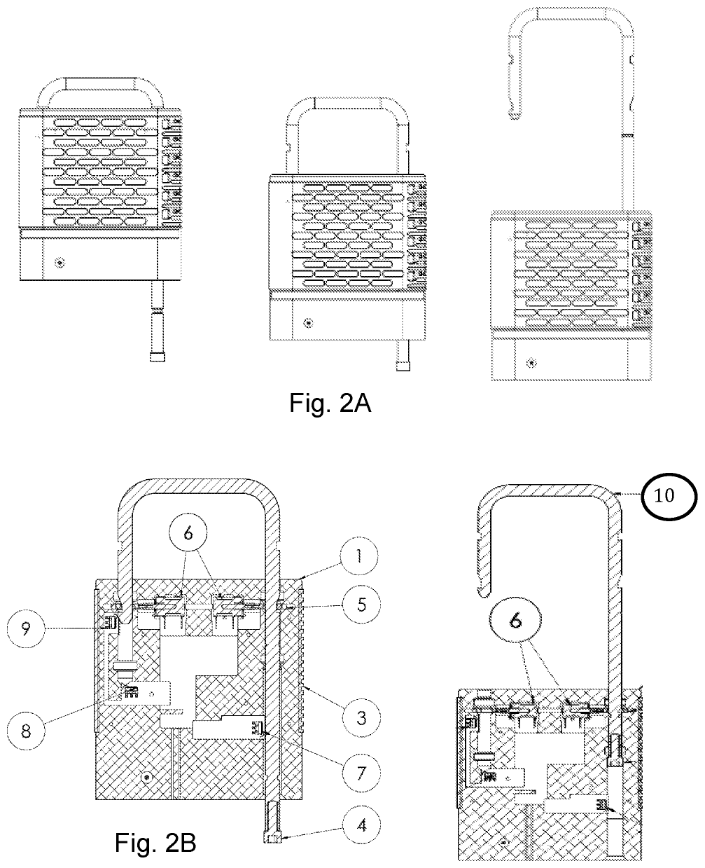

As shown in FIG. 2, the U-Lock system has a sliding U-shaped rod (10) for encircling the upper bar of a bike frame, after which an automated lock system will secure the lock in place. The lock moves between a locked configuration and unlocked configuration. This design maintains the familiar shape and usability of the contemporary U-locks while enabling automation and cloud-based technology to the system. The U-lock (1) may be mounted on a substantially vertical track that allows the locking height to adapt to most bike heights. The vertical, sliding track is located within a vertically extending tower 45. Once the U-rod is pushed back into the housing (1), the sensor (9) triggers a mechanism to start the securing sequence, whereby the two deadbolts (5) are pushed towards the groove in the U-rod (2) using the latched linear solenoids (6) until a secure engagement is detected by another sensor mounted on the linear solenoids (6). In the release sequence, the deadbolts (5) are removed using the latched linear solenoids (6) until a full disengagement is detected by the sensor mounted on the linear solenoids (6). The stopper (4) is a threaded piece that is added to the end of U-rod (2) which stops the user from completely removing the rod from the system at any time. Sensor (7) detects the removal of the U-rod (2) and will put the device into the homing sequence. In this sequence, the user pushes the U-rod (2) back into lock housing until a full insertion is detected by sensor (8), at which point the latched linear solenoids (6) are activated to push the deadbolts (5) into the second groove on the U-rod (10) until a secure engagement is detected again by the sensor mounted on the linear solenoids (6). The housing and the U-rodmay be made from a high strength material, such as stainless steel to increase security, prevent tampering, and to withstand external elements. Rubber coating (3) is applied to the outside of the system for an improved tactile feel.

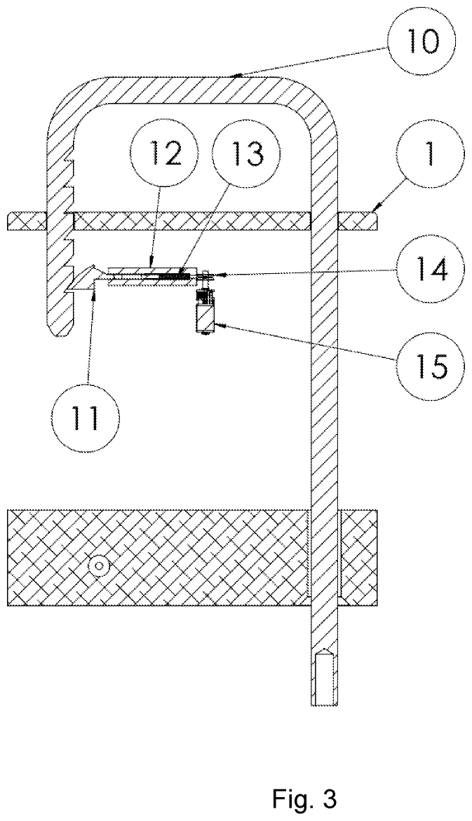

Alternatively, the automated locking mechanism for the U-rod (2) can be substituted with an automated ratcheting mechanism, as shown in FIG. 3. In this system, the spring-loaded latch (11) allows for a one-way insertion of the U-rod while mechanically stopping it from being pulled out at each of plural recesses. This system has the advantage of being adjustable to the exact size of the bike frame due to the many recesses on the U-rod (10) that can come in contact with the spring-loaded latch (11). To release this system, the geared DC motor (15) compresses the spring (13) by pulling onto the spring-loaded latch (11). This may be done using a cable and winch (14).

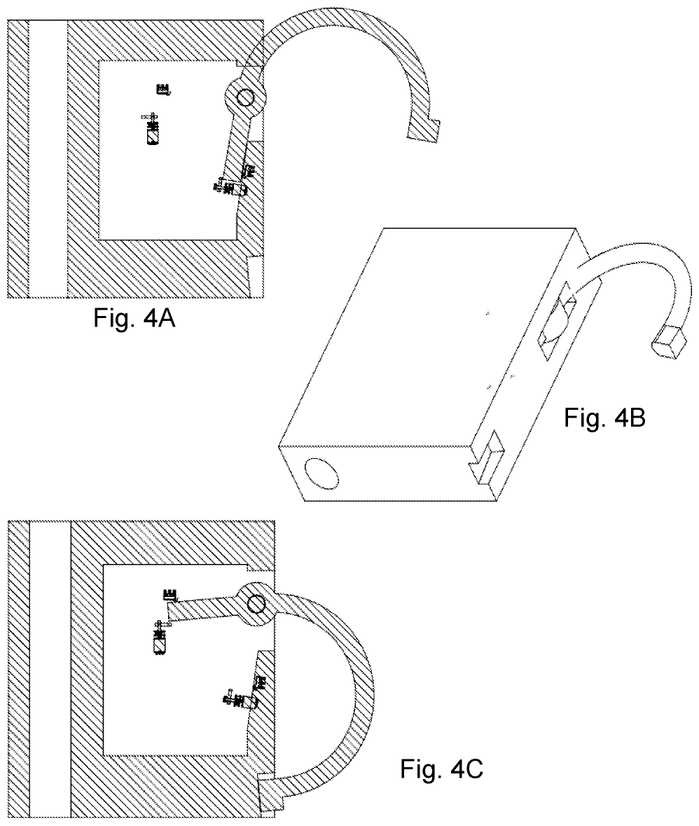

An alternative variation of the automated U-lock is to move the lock in a rotary motion, as shown in FIG. 4. At the locked and unlocked position, the U-rod can be detected by using sensors and be secured in place using a sliding or rotating deadbolt.

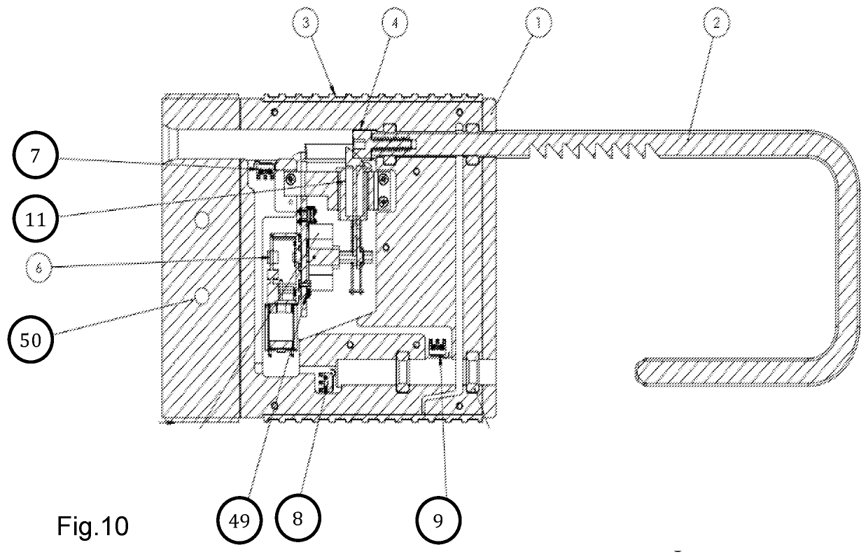

In yet another embodiment, shown in FIGS. 10, the U-Lock system is a sliding U-shaped rod (2) that encircles the upper bar of a bike frame, after which our automated lock system will secure it in place. This design maintains the familiar shape and usability of the contemporary U-locks while adding automation and cloud-based technology to the system. The U-lock (1) is mounted on a vertical track that allows it to adapt to most bike heights. Ball detents (50) are used to snap the U-lock housing to predetermined heights. Once the U-rod is pushed back into the housing, sensors (8 & 9) trigger the solenoid or motor (6) to rotate the spindle (49) to release the spring loaded latch (5). The grooves on the U-rod (2) are machined such that they allow for a one-way insertion of the U-lock while mechanically stopping it from being pulled out. The system allows the user to adjust the U-lock for the exact size of the bike frame. To release this system, the geared DC motor (6) rotates the spindle (13) and retracts the spring loaded latch (7). The stopper (4) is a threaded piece that is added to the end of U-rod (2) which stops the user from completely removing the rod from the system at any time. Sensors (7 & 9) detect the extension of the U-rod (2) and will put the device into the homing sequence. During this sequence, the user pushes the U-rod (2) back into lock housing until a full insertion is detected by sensor (8), at which point the spring loaded latch (11) is released to come in contact with grooves on the U-rod (2). The housing and the U-rod (2) is made from a high strength material such as hardened steel to increase security and prevent tampering, and to withstand external elements. Rubber coating (3) is applied to the outside of the system for a premium tactile feel.

There may be lights on the vertical tower for nighttime visibility.

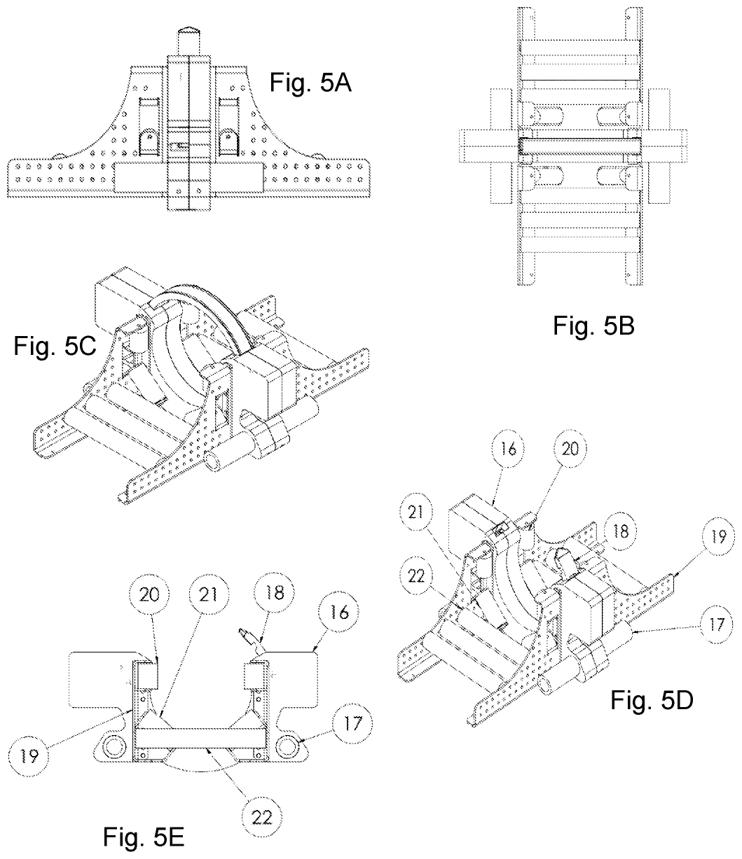

As shown in FIG. 5, a preferred wheel locking mechanism (for second and third locks) comprises a sliding or rotating, substantially C-shaped rod (18) that passes through the spokes of a bike wheel and secures it in place, preferably automatically using a latching solenoid inside the C-lock housing (16).

Each C-lock mechanism is mounted on horizontal tracks using bushings (17) that allows the system to adapt to most bike lengths by sliding within the base. The user may slide the wheel locks fore and aft to manually adjust the distance between locks. Alternatively, actuators controlled by the station's processor may automatedly displace the locks to the desired distance. The bushings (17) are preferably be made of a low-friction material such as PTFE, while the C-lock housing (16) and the circular shackle (18) may be made of a material with high strength and durability, such as stainless steel. Slanted rollers (21) and vertical rollers (20) provide a guide for the wheel to be steered in the correct direction on the C-lock while multiple horizontal rollers (22) are provided to assist the user in placing the bike and adjust the horizontal location of the C-locks. Since the horizontal rollers allow the wheel of the bike to rotate freely, the tip of the circular shackle is tapered to push the spokes of the wheel out of the way while locking, ensuring no damage is done to the bike.

The circular shackle/rod (18) may be actuated in its locking stroke by a winch (24) and a cable-and-pulley (25) system. The rod in its locked position is detected using a sensor (26), which triggers the latching linear solenoid (28) to engage the deadbolt (27) and thus secure the shackle/rod (18). To initiate the unlocking process, the latching linear solenoid (28) releases the deadbolt (27) while the geared motor (23) releases the tension in the cable. The constant coil spring (30) will then passively actuate the circular shackle back into the housing until its full retraction is detected by sensor (29), at which point the geared motor (23) stops releasing the cable.

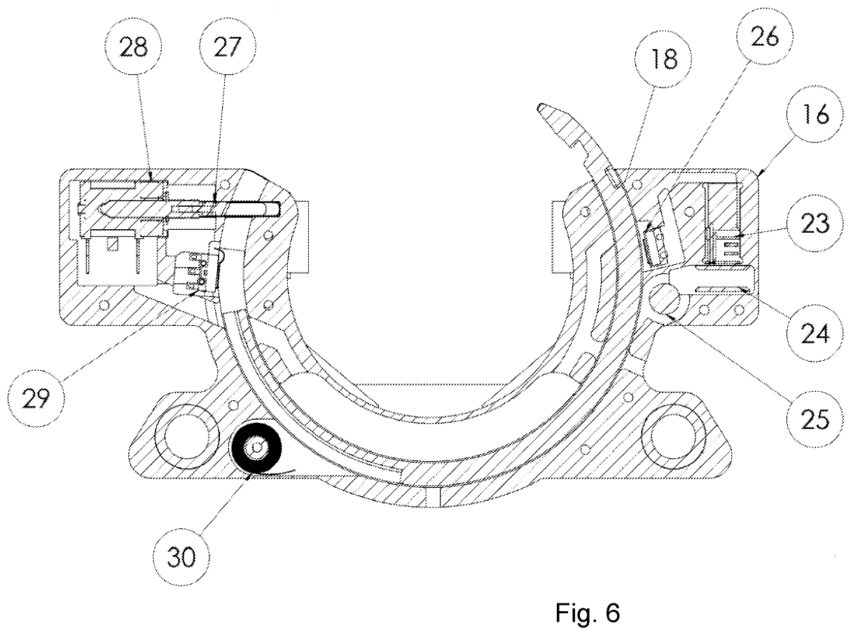

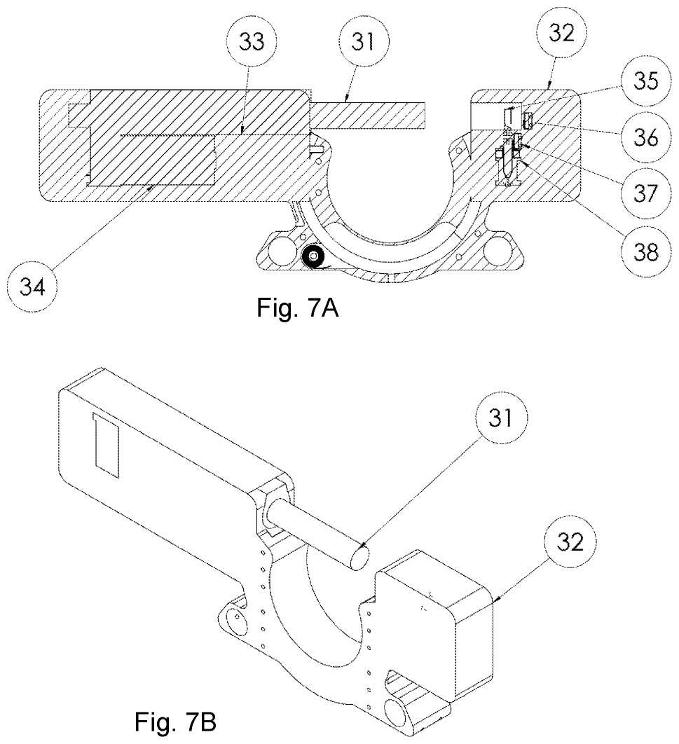

Alternatively, the rotating circular shackle shown in FIG. 6, can be replaced by a linear motion rod (31) that is actuated through the gear motor (34) as shown in FIGS. 7A, B. The jack screw assembly (33) is a structurally strong, non-back drivable, and self-locking system that can translate the rotary motion of the motor into the linear motion of the rod (31). At the end of the locking stroke, to secure the wheel of the bike, a sensor (36) triggers the actuation of the latched linear solenoid (38), which slides the deadbolt (35) into the groove of the linear motion rod. The secure engagement of this deadbolt is confirmed by another sensor (37).

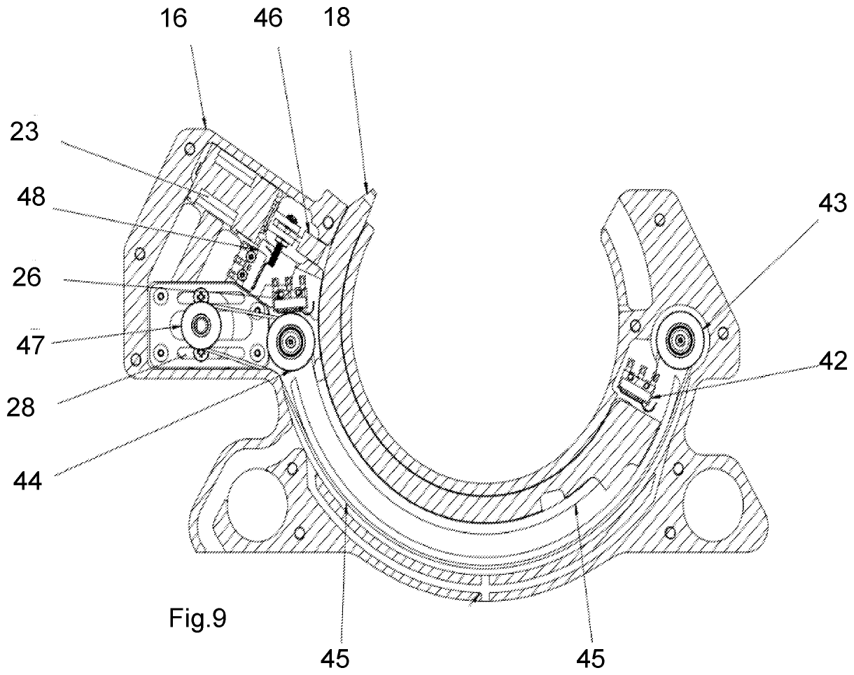

In an alternative C-lock embodiment of FIG. 9, the circular shackle (18) is actuated in its locking stroke by a belt (45) and pulley (47) system. To allow for the circular motion of the shackle, the belt is passed through concentric channels lined with low friction materials and around the two idler pulleys (44 & 43). When the shackle is in its end position, it is detected using a sensor (26), which triggers the latching linear solenoid (23) to engage the deadbolt (46) and thus secure the shackle (18). A sensor (48) confirms the successful locking of the shackle. To initiate the unlocking process, the latching linear solenoid (23) releases the deadbolt (24) while the geared motor (28) reverses its direction.

The belt (30) will then actuate the circular shackle back into the housing until its full retraction is detected by sensor (42), at which point the geared motor (28) stops the motion.

The station may be powered by one or more of battery, solar, and grid power supply. The locking station may have electric cables and plugs for charging e-bikes.

The lock station may comprise one or more tamper sensors to detect if the bike is being tampered with while the lock is engaged and trigger an alert. Tamper sensors may include: a) vibration sensors to detect movement; b) Hall-effect sensors to detect the presence of the bike's metal frame, c) cameras to capture footage of the bike, especially if the alarm is triggered; d) lock sensors to detect that the lock rod is no longer engaged; or e) microphones to listen to persons near the station.

The station's computer may process these tamper sensors or combinations thereof to set an alarm start, reportable to the administrator or user. Image and sound processing may be employed to differentiate between ambient sensor ‘noise’ and an actual theft or tamper. For example, a suitably trained Convolutional Neural Net can distinguish between a bike and a person working on the bike/lock.

### Operation

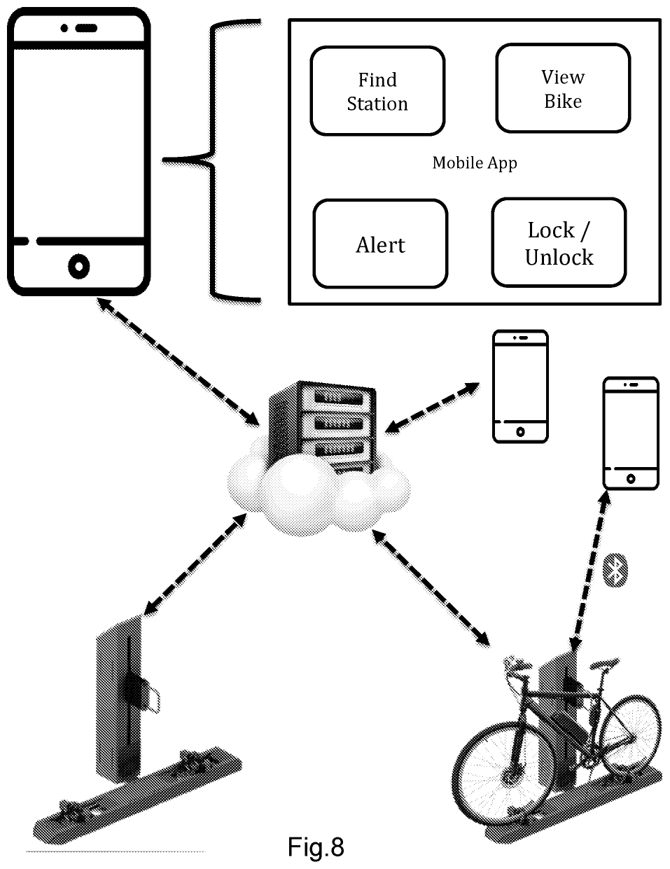

The locking station system may utilize cloud-based apps running on mobile computing devices to connect users to a modular locking infrastructure comprised of plural locking stations in order to automatedly lock their bikes' frame, wheels, and accessories (optional). These instructions pass from user to user to lock station via a server, as shown in FIG. 8.

The app may utilize the mobile device's GPS and wireless connection to identify bike lock station locations on a map, displayable on the computing device. The user can register and enter their payment information and register their bike details and serial number for tracking as well as for insurance purposes involving local government bike theft prevention programs.

The app provides means to search for available bike locking stations on the app based on their GPS location or in a specified area of preference. The app provides means to reserve a bike lock station for a period prior to arrival to the destination. Once the customer arrives at the bike locking station, they can use their computing device to unlock the locks via NFC/RFID/WIFI/CELL. The app provides means to guide the user through the locking process. In response to a user-requested LOCK (or UNLOCK) instruction, the station may activate the lock actuators to close (or open) the locks. The station may pass back the state of the lock or further instructions, such as to move the bike into a better position.

There may be sensors on the station that communicate to the user via the app's user interface to indicate whether a lock has been accidentally left unlocked, not properly engaged, or tampered with. Similarly such sensors maybe continually monitored by the lock station to determine whether the bike or lock are being tampered with and then alert the user via the App. The App may receive a live camera feed from a station associated with that user's bike to display to the user. Footage can be captured and downloaded from the user's account on the mobile app for a period of time before it is deleted.

The App may also provide a “bike share” function, thru which a user can authenticate a friend's access to a locked bike. For example, the user may provide the identification of the friend (e.g., username, account ID) and digitally sign an authentication, which can be opened on the friend's mobile computing device.

Terms such as “top”, “bottom”, “distal”, “proximate”, “below,” “above,” “upper, are used herein for simplicity in describing relative positioning of elements of the bike or station, as depicted in the drawings or with reference to the surface datum. Although the present invention has been described and illustrated with respect to preferred embodiments and preferred uses thereof, it is not to be so limited since modifications and changes can be made therein which are within the full, intended scope of the invention as understood by those skilled in the art.

1. A bicycle locking station comprising:
a vertically extending structure having an adjustable height bike-frame lock; and
a ground-engaging base having two wheel locks and mechanism to adjust the distance between the wheel locks.

2. The station of claim 1, further comprising a computer processor and actuators operatively coupled thereto for controlling the locks.

3. The station of claim 1, further comprising actuators within the station. mechanically coupled to locking rods of the locks to drive the rods between a locked and unlocked position.

4. The station of claim 1, further comprising lock sensors for determining whether the locks are in a locked or unlocked position.

5. The station of claim 1, wherein the base comprises rollers proximate the wheel locks to support wheels of the bicycle.

6. The station of claim 1, further comprising an electrical power supply and cable for charging e-bikes.

7. The station of claim 1, wherein the bike-frame lock is mounted to and vertically adjustable relative to the vertically extending structure by an actuator to accommodate bicycles of different sizes.

8. The station of claim 1, wherein the vertically extending structure has a vertical channel for slidably receiving the biked frame lock.

9. The station of claim 1, wherein the vertically extending structure is connected to the base.

10. The station of claim 1, wherein the bike-frame lock is a U-shaped lock, slidable to create a gap through which a bicycle's frame may pass.

11. The station of claim 1, wherein the wheel locks comprise C-shaped shackles, rotatable to lock around the bicycle's wheels.

12. The station of claim 1, further comprising a plurality of ganged structures, bases and locks to lock several bicycles individually.

13. The station of claim 1, further comprising telecommunications hardware for exchanging data with a mobile app or server.

14. A method of locking a bicycle comprising:
positioning the bicycle beside a locking station having three locks;
adjusting the height of a frame lock of the station and engaging that lock around the frame of the bicycle; and
adjusting the horizontal distance between two wheel locks and engaging each with a wheel of the bicycle.

15. The method of claim 14, further comprising unlocking and locking the locks using actuators within the station.

16. The method of claim 14, further comprising determining whether the locks are in a locked or unlocked position using lock sensors.

17. The method of claim 14, further comprising charging the bicycle using a cable powered by the station.

18. The method of claim 14, wherein the height of the frame lock is adjusted using an actuator within the station.

19. The method of claim 14, further comprising associating a user with one locking station in a plurality of ganged locking structures and controlling each station when instructed by that user.

20. The method of claim 14, further comprising exchanging data with a mobile app or server regarding the state of the locks or instructions from a user.
